(19) United States
(12) Patent Application Publication
(10) Pub. No.: US 2014/0118809 A1
(43) Pub. Date: May 1, 2014

(54) OPTICAL SCANNING DEVICE, IMAGE DISPLAY APPARATUS AND OPTICAL SCANNING METHOD

(71) Applicants: Takeshi Honda, Tokyo (JP); Kenji Tagami, Tokyo (JP); Nobuaki Takanashi, Tokyo (JP)

(72) Inventors: Takeshi Honda, Tokyo (JP); Kenji Tagami, Tokyo (JP); Nobuaki Takanashi, Tokyo (JP)

(73) Assignee: NEC CORPORATION, Tokyo (JP)

(21) Appl. No.: 14/128,512

(22) PCT Filed: Jun. 8, 2012
(86) PCT No.: PCT/JP2012/064800

§ 371 Date: Dec. 20, 2013

(30) Foreign Application Priority Data
Jul. 6, 2011 (JP) 2011-150227

(51) Int. Cl. G02B 26/10

(52) U.S. Cl. CPC G02B 26/10
USPC 359/199.3

(57) ABSTRACT

Provided is an optical scanning device capable of solving the problem of low driving efficiency. A pair of coupling parts 12 join both ends of movable mirror part 11 having a reflective plane that reflects light to respective supporting parts 13. Each coupling part 12 has magnet part 21 having a permanent magnet, first spring part 22 that couples magnet part 21 to supporting part 13 in an oscillatable manner, and a second spring part that couples movable mirror part 11 to magnet part 21 in an oscillatable manner. Driver 14 generates magnetic fields acting on magnet part 21 to oscillate magnetic part 21 and thereby oscillate movable mirror part 11.

### TECHNICAL FIELD

The present invention relates to an optical scanning device, an image display apparatus and an optical scanning method.

### BACKGROUND ART

Optical scanning devices that scan light by means of a mirror have been widely used in digital copiers, laser printers, barcode readers, scanners, projectors and others. Conventionally, rotational types that use a motor to rotate a polygon mirror or galvano-mirror, have been predominantly used as optical scanning devices. However, in recent years, with the development of micromachining technology, use of MEMS (Micro Electro Mechanical Systems) has become widespread.

As an optical scanning device that uses the MEMS, there is a configuration which includes a movable part that is equipped with a mirror and a magnet, that is supported at both ends by a coupling part formed of an elastic material and that scans light by applying magnetic fields to the magnet to thereby oscillate the movable part on the coupling part as an oscillating axis. Differing from those that rotate a polygon mirror or a glavano-mirror by means of a motor, the optical scanning device of this kind, does not require a mechanical driving mechanism such as a motor, so that the structure becomes simple, thus making it possible to achieve miniaturization and provide a low-cost configuration (see Patent Document 1).

### RELATED ART DOCUMENT

### Patent Document

Patent Document 1: JP2005-173411A

### SUMMARY OF THE INVENTION

### Problems to be Solved by the Invention

However, because the above optical scanning device uses a mirror and a magnet in the movable part, the moment of inertia of the movable part is large. As a result, a large driving force is needed to oscillate the movable part, posing a problem that the driving efficiency for driving the movable part is low.

The object of the present invention is to provide an optical scanning device, an image display apparatus and an optical scanning method, which can solve the aforementioned problem, or the problem of low driving efficiency.

### Means for Solving the Problems

An optical scanning device according to the present invention includes: supporting parts; a movable part having a reflective plane that reflects light; a pair of coupling parts that join both ends of the movable part to the supporting parts; and, a driver for oscillating the movable part, wherein each coupling part includes: a permanent magnet; a first elastic part that joins the permanent magnet to the supporting part in an oscillatable manner; and, a second elastic part that joins the movable part to the permanent magnet in an oscillatable manner, and the driver generates magnetic fields that act acting on the permanent magnet to oscillate the permanent magnet, thereby oscillating movable part.

An image display apparatus according to the present invention includes the above optical scanning device.

An optical scanning method according to the present invention is an optical scanning method that uses an optical scanning device including a movable part having a reflective plane that reflects light, a permanent magnet and an elastic part that joins the permanent magnet and the movable part, comprising the steps of: oscillating the movable part by generating magnetic fields acting on the permanent magnet so as to oscillate the permanent magnet and transmitting the oscillation of the permanent magnet to the movable part through the elastic part; and, causing light to be incident on the reflective plane of the movable part.

### Effect of the Invention

According to the present invention, it is possible to improve driving efficiency.

### BRIEF DESCRIPTION OF THE DRAWINGS

FIG. 1 is a top view of an optical scanning device according to the first exemplary embodiment of the present invention.

FIG. 2 is a perspective view showing part of an optical scanning device according to the first exemplary embodiment of the present invention.

FIG. 3 is a sectional view of an optical scanning device according to the first exemplary embodiment of the present invention.

FIG. 4 is a diagram showing one example of a state in which a movable mirror part is moving.

FIG. 5 is a diagram showing another example of a state in which a movable mirror part is moving.

FIG. 6 is a chart showing the relationships between the tilt angle of a movable mirror part and the driving frequency which is the frequency of an a.c. current to be applied to a coil.

FIG. 7 is a diagram showing one example of an image display apparatus using an optical scanning device.

FIG. 8 is a top view of an optical scanning device according to the second exemplary embodiment of the present invention.

FIG. 9 is sectional view of an optical scanning device according to the second exemplary embodiment of the present invention.

FIG. 10 is a top view of an optical scanning device according to the third exemplary embodiment of the present invention.

FIG. 11 is a diagram for illustrating one example of an oscillation mode of a first spring part.

FIG. 12 is a top view of an optical scanning device according to the fourth exemplary embodiment of the present invention.

### MODE FOR CARRYING OUT THE INVENTION

Next, the exemplary embodiments of the present invention will be described with reference to the drawings. Here, in the description hereinbelow, those having the same functions are allotted the same reference numerals, and description of those may be omitted.

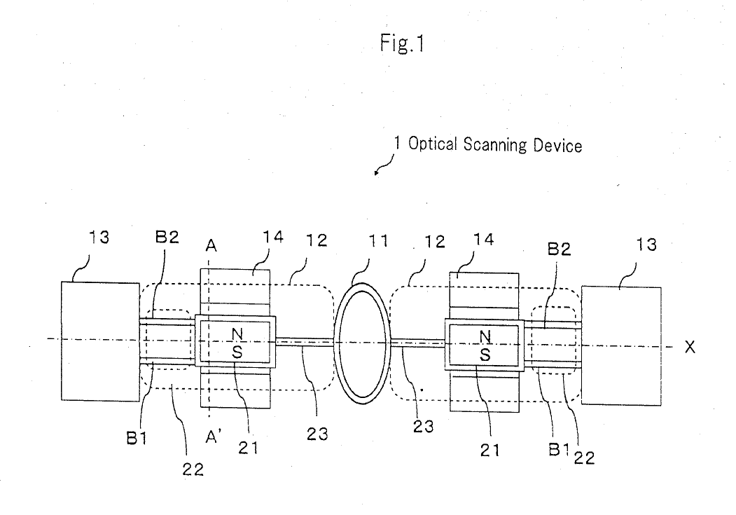

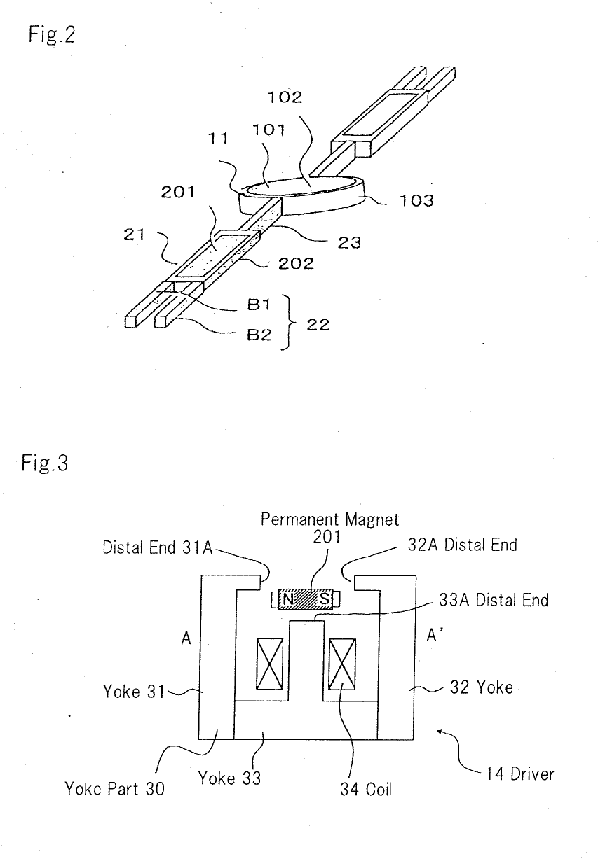

FIG. 1 is a top view of an optical scanning device according to the first exemplary embodiment of the present invention. FIG. 2 is a perspective view showing part of the optical scanning device shown in FIG. 1.

As shown in FIG. 1, optical scanning device 1 of the present exemplary embodiment includes movable mirror part 11, a pair of coupling parts 12, a pair of supporting parts 13 and a pair of drivers 14.

Movable mirror part 11 is a movable part that includes a reflective plane that reflects light and scans light by means of the reflective plane. More specifically, movable mirror part 11 includes, as shown in FIG. 2, mirror 102 having reflective plane 101 that reflects light and mirror frame 103 in which mirror 102 is fitted.

Mirror 102 is fitted in mirror frame 103 so that reflective plane 101 is exposed, and is fixed to magnet frame 202B with an adhesive or the like. Reflective plane 101 and mirror 102 are formed in an elliptic shape. As to the dimensions of mirror 102, for example, the mirror length or the dimension of the major axis of reflective plane 101 is 6 mm, the mirror width or the dimension of the minor axis of reflective plane 101 is 3 mm, and the thickness is 0.3 mm.

A pair of coupling parts 12 join each end of movable mirror part 11 to corresponding supporting part 13. More specifically, a pair of coupling parts 12 are connected to respective ends of movable mirror part 11 so as to positioned oppose to each other and the each extends in the direction of the minor axis of mirror 102 to supporting part 13. Here, though supporting part 13 may be joined in either the minor or major axis direction, improved driving efficiency can be obtained when it is joined in the direction of the minor axis.

Further, each coupling part 12 has magnet part 21, first spring part and second spring part.

Magnet part 21 includes a permanent magnet. More specifically, magnet part 21 has permanent magnet 201 and magnet frame 202 in which permanent magnet 201 is embedded. Permanent magnet 201 is embedded in magnet frame 202 such that the direction of magnetization lies perpendicular or approximately perpendicular to the extended direction of coupling parts 12 and is fixed to magnet frame 202B with an adhesive or the like.

First spring part 22 is a first elastic part that is extended in the direction of the minor axis of mirror 102 and joins magnet part 21 to supporting part 13 in an oscillatable manner. Second spring part 23 is a second elastic part that is extended in the same direction as first spring part 22 is, or in the direction of the minor axis of mirror 102 and joins movable mirror part 11 to magnet part 21 in an oscillatable manner.

Here, the member that joins magnet part 21 to supporting part 13, as well as the member that joins movable mirror part 11 to the magnet, is not limited to a spring but may work as long as it is an elastic body.

First spring part 22 may be formed of a plurality of elastic parts that are arranged in parallel and that are connected to permanent magnet 201 and supporting part 13. First spring 22 shown FIG. 1 is formed of two springs (spring B1 and B2) as the aforementioned elastic bodies.

Each driver 14 is formed so as to enclose magnet part 21 of each coupling part 12 and functions to oscillate movable mirror part 11 on the minor-axis direction of mirror 102 as oscillation axis X by applying magnetic fields to the enclosed magnet part 21.

FIG. 3 is a diagram for detailedly explaining the configuration of driver 14, showing a section cut along line A-A′ of optical scanning device 1 shown in FIG. 1.

Driver 14 includes yoke part 30 as a magnetic circuit and coil 34 wound on yoke part 30.

Yoke part 30 is formed of three magnetically coupled components (yokes 31 to 33).

Yoke 31 has distal end 31A near one of the poles of permanent magnet 201 while yoke 32 has distal end 32A near the other pole of permanent magnet 201, at a position on the opposite side across permanent magnet 201 from distal end 32A. Yoke 33 has a distal end 33A laid in the direction perpendicular to the magnetized direction of the permanent magnet (more specifically, near the bottom surface of permanent magnet 201). Coil 34 is wound around yoke 33.

When current flows through coil 34, the coil excites yoke part 30 that lead s to the generation of produce magnetic fields acting on permanent magnet 201. Here in the present exemplary embodiment, coil 34 is wound on yoke 33 so that the magnetic poles at distal ends 31A and 32A and the magnetic pole of distal end 33A become dissimilar from each other.

In the thus configured optical scanning device 1, when current flows through coil 34, magnetic flux is generated inside yoke part 30 so that magnetic poles are created at distal ends 31A to 33A of yokes 31 to 33. At this time, distal ends 31A and 32A and distal end 33A form different magnetic poles from each other, so that magnetic fields form between distal ends 31A and 33A and between distal ends 32A and 33A.

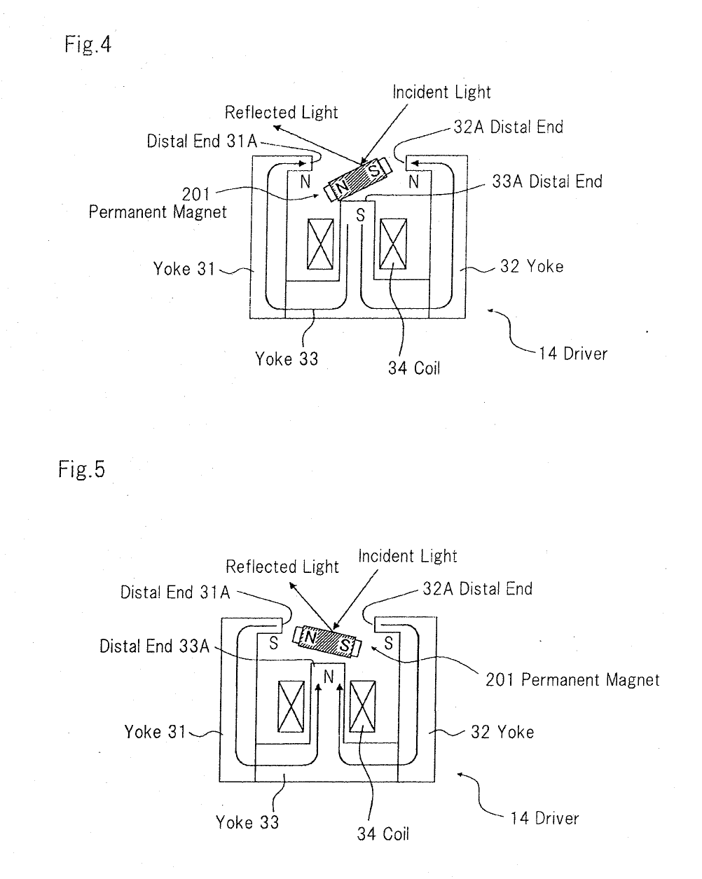

For example, suppose that when current flows through the coil in the first direction the N-pole is formed at distal ends 31A and 32A while the S-pole is formed at the distal end 33A, as shown in FIG. 4. In this case, magnetic fields are generated from distal ends 31A and 32A toward distal end 33A. This magnetic fields acts on permanent magnet 201 so that the S-pole of permanent magnet 201 and the N-pole of distal end 33 attract each other, whereby permanent magnet 201 tilts the bonded magnet part 21 to the left side in the drawing.

When current flows through coil 34 in the second direction, or the direction opposite to the first direction, as shown in FIG. 5 the S-pole is formed at distal ends 31A and 32A while the N-pole is formed at the distal end 33A. In this case, magnetic fields are generated from distal end 33A toward distal ends 31A and 32A. This magnetic field acts on permanent magnet 201 so that the N-pole of permanent magnet 201 and the S-pole of distal end 33 attract each other, whereby permanent magnet 201 tilts the bonded magnet part 21 to the right side in the drawing.

Accordingly, as an a.c. current is applied to coil 34, magnet part 21 oscillates around oscillation axis X as a center. The oscillation of magnet part 21 twists second spring part 23 to thereby move forward to movable mirror part 11 so that movable mirror part 11 also oscillates about oscillation axis X. Here, the waveform of the a.c. current is preferably sinusoidal.

In this configuration, if an a.c. current is applied to coil 34 so as to cause the oscillation system that is formed of movable mirror part 11, magnet part 21, first spring part 22 and second spring part 23 to resonate, it is possible to make the tilt angle of movable mirror part 11 greater at low currents.

The equation of motion of the above oscillation system is expressed as follows:

$${I}_{1} \frac{{d}^{2} {θ}_{1}}{d {t}^{2}} + c ( \frac{d {θ}_{1}}{d t} - \frac{d {θ}_{2}}{d t} ) + ( {k}_{1} + {k}_{2} ) {θ}_{1} - {k}_{2} {θ}_{2} = {T}_{q} cos ( ω t ) \\ {I}_{2} \frac{{d}^{2} {θ}_{2}}{d {t}^{2}} - c ( \frac{d {θ}_{1}}{d t} - \frac{d {θ}_{2}}{d t} ) - {k}_{2} ( {θ}_{1} - {θ}_{2} ) = 0 \qquad [ Math 1 ]$$

where, I₁ is the moment of inertia of magnet part 21, 2I₂ is the moment of inertia of movable mirror part 11, c is the attenuation coefficient of the oscillation system, θ₁ is the angle of oscillation of magnet part 21, θ₂ the angle of oscillation of the movable mirror part, k1 the spring constant of first spring part 22, k2 is the spring constant of second spring part 23, ω is the driving frequency of the frequency of the a.c. current to be applied to coil 34, and T_{q} is the torque acting on magnet part 21. Here, it is assumed that the same a.c. current flows through coil 34 of each magnet part 21 and oscillation angle θ₁ and the moment of inertia of each magnet part 21 are equal.

As movable mirror part 11 oscillates as above, movable mirror part 11 can reflect light incident at a certain angle in various directions. For example, movable mirror part 11 can reflect light incident at a certain angle, at a shallow angle, as shown in FIG. 4, or reflect the beam at a deep angle as shown in FIG. 5. In this way, it is possible to change the angle of the scanning light arbitrarily by changing the direction and magnitude of the current flowing through coil 34.

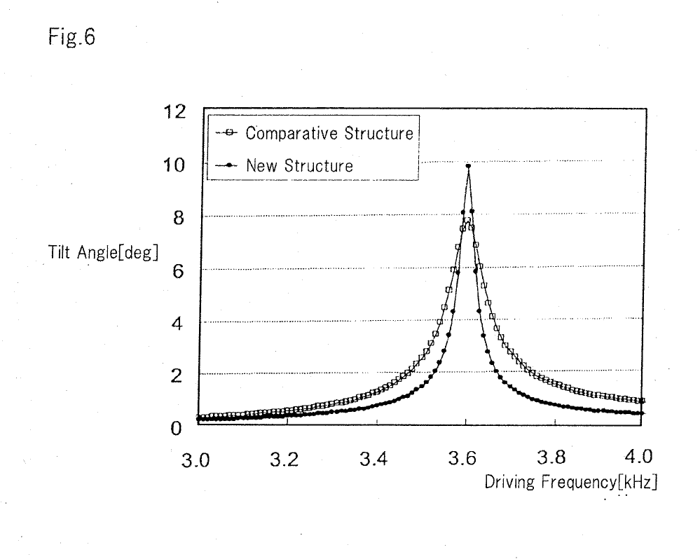

FIG. 6 is a chart showing the relationship between the tilt angle of movable mirror part 11 and the driving frequency. In FIG. 6, as a comparative example to optical scanning device 1 of the present exemplary embodiment (referred to as new structure in FIG. 6), the relationship between the tilt angle of the movable part and the driving frequency of an optical scanning device having a movable mirror part including both a mirror and a magnet (referred to as comparative structure in FIG. 6) is also shown.

As shown in FIG. 6, when the driving frequency is set so as to cause torsional resonance in the oscillation systems, the tilt angle of movable mirror part 11 in optical scanning device 1 of the present exemplary embodiment becomes greater with the same driving force, compared to the optical scanning device of the comparative structure. This is because movable mirror part 11 is oscillated via second spring part 23 when permanent magnet 201 is oscillated. As a result, it is possible to improve driving efficiency.

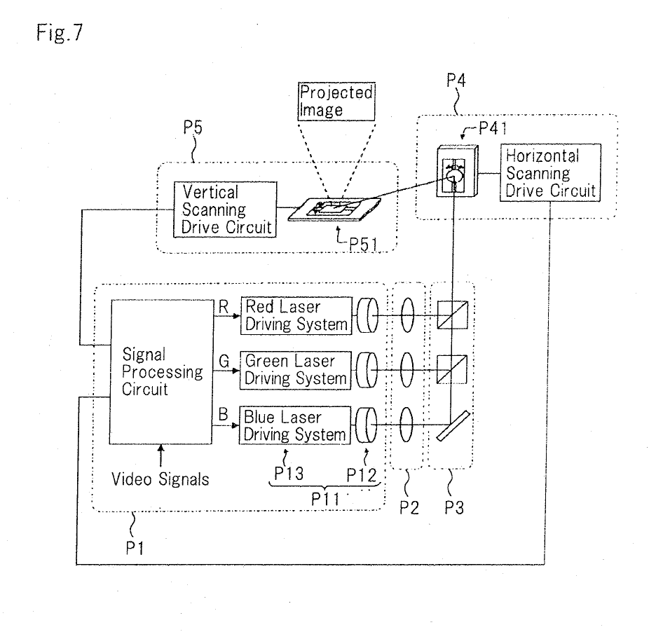

FIG. 7 is a diagram showing one example of an image display apparatus using optical scanning device 1.

As shown in FIG. 7, the image display apparatus includes: light beam generating device P1 for generating light beams of different colors modulated in accordance with video signals input from without; collimating optical system P2 for collimating each light beam generated by light beam generating device P1; and synthesizing optical system P3 for synthesizing the collimated light beams. The image displaying apparatus further includes: horizontal scanning portion P4 for scanning the light beam combined through the synthesizing optical system P3 in the horizontal direction so as to perform image display; vertical scanning portion P5 for scanning the light beam scanned horizontally by horizontal scanning portion P4 in the vertical direction; and an optical system (not shown) for projecting the light beam scanned horizontally and vertically onto a screen. Optical scanning device 1 of the present exemplary embodiment is provided in the form of scanning mirror P41 of horizontal scanning portion P4 and assembled in the image display apparatus.

Light beam generating device P1 has a signal processing circuit which receives a video signal and generates signals to be the elements that form an image, based on the input signal and which outputs a horizontal synchronization signal to be used by the horizontal scanning portion and a vertical synchronization signal to be used by the vertical scanning portion. In this signal processing circuit, video signals of red (R), green (G) and blue (B) are produced.

Further, light beam generating device P1 has light source units P11 for forming different light beams of the three video signals (R, G, B) output from the signal processing circuit. Light source unit P11 includes laser P12 for generating a light beam and laser driving system P13 for driving the beam, for the video signal of each color. A semiconductor laser or solid-state high harmonic generator (SHG) laser may preferably be used for each laser.

The light beam of each color emitted from each laser P12 of light beam generating device P1 is collimated by means of collimating optical system P2, then is caused to be incident onto the dichroic mirror for the corresponding color in synthesizing optical system P3. The light beams of different colors incident on these three dichroic mirrors are reflected or transmitted selectively on a wavelength-wise basis and are synthesized to be output to horizontal scanning portion P4.

In horizontal scanning portion P4 and vertical scanning portion P5, the light beam incident on horizontal scanning portion P4 is projected as an image by scanning mirrors P41 and P51 horizontally and vertically. Here, scanning mirrors P41 and P51 are driven by a scanning drive circuit, based on the synchronization signals output from the signal processing circuit.

As described heretofore, according to the present exemplary embodiment, the oscillation of permanent magnet 201 is transmitted to movable mirror part 11 to thereby oscillate movable mirror part 11. Accordingly, it is possible to make the moment of inertia of the oscillating system small, hence improve driving efficiency.

Next, the second exemplary embodiment of the present invention will be described.

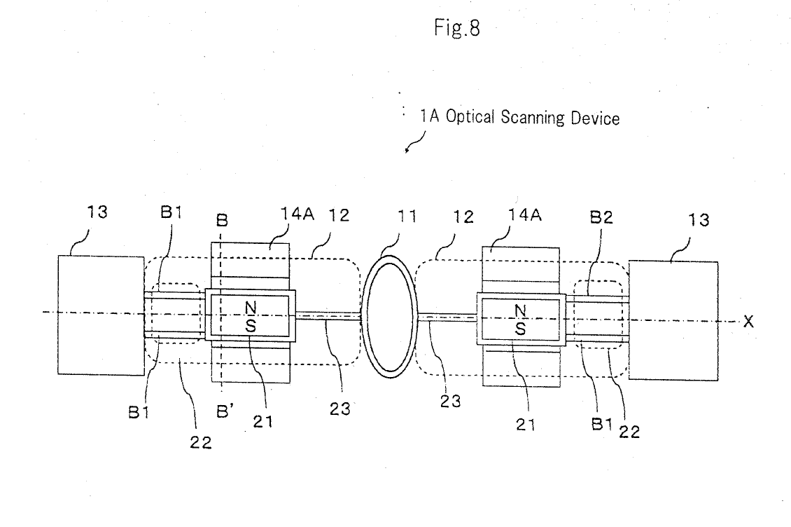

FIG. 8 is a top view of an optical scanning device according to the present exemplary embodiment. As shown in FIG. 8, optical scanning device 1A of the present exemplary embodiment is different from optical scanning device 1 shown in FIG. 1, in that a pair of drivers 14 are replaced by a pair of drivers 14A.

Each driver 14A is formed so as to enclose magnet part 21 of each coupling part 12 and functions to oscillate movable mirror part 11 on the minor-axis direction of mirror 102 as oscillation axis X by applying magnetic fields to the magnet part 21.

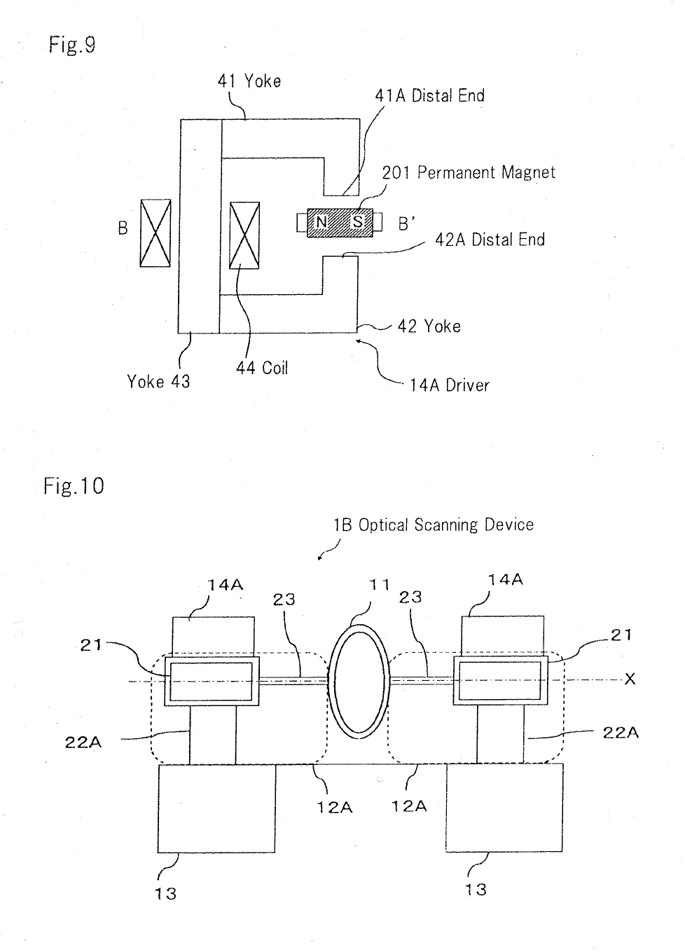

FIG. 9 is a diagram for explaining the configuration of driver 14A in more detail, showing a section cut along line B-B′ of optical scanning device 1A shown in FIG. 8.

Driver 14A includes yoke part 40 as a magnetic circuit and coil 44 wound on yoke part 40.

Yoke part 40 is formed of three magnetically coupled components (yokes 41 to 43).

Yoke 41 has distal end 41A near the top face of permanent magnet 201 while yoke 42 has distal end 42A near the bottom face of permanent magnet 201 at a position on the opposite side across permanent magnet 201 from distal end 41A. Accordingly, yoke part 40 has a pair of distal ends (distal ends 41A and 42A) arranged in the direction perpendicular to the magnetized direction of permanent magnet 201 so as to be positioned opposite each other with permanent magnet 201 therebetween. Yoke 43 has no distal end that is close to permanent magnet 201. Coil 44 is wound around yoke 43.

When current flows through coil 44, the coil excites yoke part 40 so as to produce magnetic fields acting on permanent magnet 201. Here in the present exemplary embodiment, coil 44 is configured so that the magnetic poles at distal ends 41A and 42A are different from each other.

Also in the present exemplary embodiment, similarly to the first exemplary embodiment, the oscillation of permanent magnet 201 is transmitted to movable mirror part 11 to thereby oscillate movable mirror part 11. Accordingly, it is possible to improve driving efficiency.

Further, since distal ends 41A and 42A can be made closer, compared to the first exemplary embodiment, it is possible to efficiently generate magnetic fields that act on permanent magnet 201.

Next, the third exemplary embodiment of the present invention will be described.

FIG. 10 is a top view of an optical scanning device according to the present exemplary embodiment. As shown in FIG. 10, optical scanning device 1B of the present exemplary embodiment is different from optical scanning device 1A shown in FIG. 8, in that a pair of coupling parts 12 are replaced by a pair of coupling parts 12A.

A pair of coupling parts 12A join both ends of movable mirror part 11 to respective supporting parts 13. More specifically, a pair of coupling parts 12A are connected to the respective ends of movable mirror part 11, and each extended in the direction of the minor axis of mirror 102 and is bent at a halfway position to the direction of the major axis of mirror 102 and further extended and connected to corresponding supporting part 13.

Each coupling part 12A includes magnet part 21, first spring part 22A and second spring part 23. First spring part 22A is the first elastic part that is extended in the direction of the major axis of mirror 102 and couples magnet part 21 to supporting part 13 in an oscillatable manner. Here, first spring part 22A is formed of a single spring.

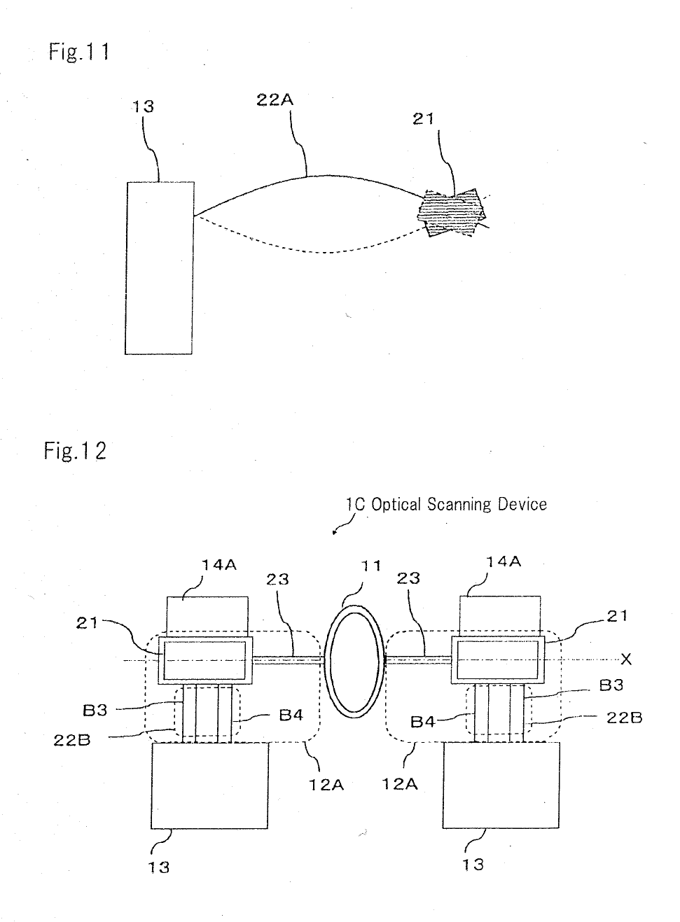

In optical scanning device 1B shown in FIG. 10, when an a.c. current flows through coil 44 of driver 14A to apply magnetic fields to magnet part 21, magnet part 21 oscillates about oscillation axis X and second spring part 23 is twisted. As a result, the oscillation is transmitted to movable mirror part 11, hence movable mirror part 11 also oscillates about the oscillation axis X. On the other hand, since first spring part 22 lies in a direction perpendicular to oscillation axis X (the direction of the minor axis of mirror 102), first spring part 22A oscillates up and down as magnet 21 oscillates about oscillation axis X. At this time, it is preferable that first spring part 22A is adapted to oscillate in the 2-node mode (2^{nd} mode) or have nodes at supporting part 13 and magnet part 21, as shown in FIG. 11.

In the present exemplary embodiment, since, similarly to the first exemplary embodiment, the oscillation of permanent magnet 201 is transmitted to movable mirror part 11 to thereby oscillate movable mirror part 11, it is possible to improve driving efficiency. Further, since first spring part 22A and second spring part 23 lie in directions different from each other, it is possible to shorten the length of the lateral direction (X-axis direction).

Next, the fourth exemplary embodiment of the present invention will be described.

FIG. 12 is a top view of an optical scanning device according to the present exemplary embodiment. Optical scanning device 1C shown in FIG. 12 is different from optical scanning device 1B shown in FIG. 10, in that instead of first spring parts 22A, a plurality of spring parts include first spring parts 22B having a plurality of springs arranged in parallel. More specifically, first spring part 22B has two springs (springs B3 and B4) as above.

In the present exemplary embodiment, since first spring part 22B has a plurality of springs arranged in parallel, it is possible to shorten the length of first spring part 22B.

In each of the above-described exemplary embodiments, the illustrated configuration is a mere example, and the present invention should not be limited to the above configurations.

This application claims priority based on Japanese Patent Application No. 2011-150227, filed on Jul. 6, 2011, and incorporates all the disclosure thereof herein.

### Description of Reference Numerals

1, 1A to 1C optical scanning device
11 movable mirror part
12, 12A coupling part
13 supporting part
14, 14A driver
21 magnet part
22, 22A, 22B first spring part
23 second spring part
30, 40 yoke part
31 to 33, 41 to 43 yoke
31A, 32A, 33A, 41A, 42A distal end
34 coil
101 reflective plane,
102 mirror
103 mirror frame
201 permanent magnet
202 magnet frame

1. An optical scanning device, comprising: supporting parts; a movable part having a reflective plane that reflects light; a pair of coupling parts that join both ends of the movable part to the supporting parts; and, a driver for oscillating the movable part, wherein
each of the coupling parts includes:
a permanent magnet;
a first elastic part that joins the permanent magnet to the supporting part in an oscillatable manner; and,
a second elastic part that joins the movable part to the permanent magnet in an oscillatable manner, and
said driver that generates magnetic fields acting on the permanent magnet to oscillate the permanent magnet, and thereby oscillate movable part.

2. The optical scanning device according to claim 1, wherein
the driver includes:
a yoke part; and
a coil that is wound on the yoke part and generates the magnetic fields by exciting the yoke part when current flows therethrough.

3. The optical scanning device according to claim 2, wherein
the yoke part includes:
a pair of first distal ends that are arranged in the magnetized direction of the permanent magnet so as to be positioned opposite to each other with permanent magnet therebetween; and,
a second distal end that is arranged in the direction perpendicular to the magnetized direction of the permanent magnet, and
said coil that is wound on the yoke part so that the first distal ends and the second distal end form different magnetic poles from each other.

4. The optical scanning device according to claim 2, wherein
the yoke part has a pair of distal ends arranged in the direction perpendicular to the magnetized direction of the permanent magnet so as to oppose each other with the permanent magnet therebetween, and
the coil is wound on the yoke part so that each end forms a different magnetic pole from that of the other.

5. The optical scanning device according to claim 1, wherein the first elastic part and the second elastic part are extended in the same direction.

6. The optical scanning device according to claim 1, wherein the first elastic part and the second elastic part are extended in the directions perpendicular to each other.

7. The optical scanning device according to claim 1, wherein in the first elastic part, a plurality of elastic bodies connected between the permanent magnet and the supporting part are arranged in parallel.

8. The optical scanning device according to claim 1, wherein the movable part has an elliptic mirror having the reflective plane, and the second elastic part is extended in the direction of the minor axis of the mirror.

9. An image display apparatus having an optical scanning device according to claim 1.

10. An optical scanning method by means of an optical scanning device including a movable part having a reflective plane that reflects light, a permanent magnet and an elastic part that joins the permanent magnet and the movable part, comprising the steps of:
oscillating the movable part by generating magnetic fields acting on the permanent magnet so as to oscillate the permanent magnet and transmitting the oscillation of the permanent magnet to the movable part through the elastic part; and,
causing light to incident on the reflective plane of the movable part.
